(19) United States
(12) Patent Application Publication
(10) Pub. No.: US 2011/0317301 A1
(43) Pub. Date: Dec. 29, 2011

(54) NONLINEARITY MEASUREMENT APPARATUS, NONLINEARITY MEASUREMENT METHOD, AND MAGNETIC RECORDING AND REPRODUCTION APPARATUS

(75) Inventor: Hiroaki UENO, Tokyo (JP)

(73) Assignee: Kabushiki Kaisha Toshiba, Tokyo (JP)

(21) Appl. No.: 13/021,740

(22) Filed: Feb. 5, 2011

(30) Foreign Application Priority Data
Jun. 24, 2010 (JP) 2010-144002

(51) Int. Cl. G11B 20/18; G11B 27/36

(52) U.S. Cl. 360/31; 360/40; G9B/27.052; G9B/20.046

(57) ABSTRACT

According to one embodiment, a non-linearity measurement apparatus includes a first measurement module, a second measurement module, and a calculation module. The first measurement module is configured to measure a component of a first higher harmonic from a reproduced signal of a first signal recorded on a magnetic recording medium. The second measurement module is configured to measure a component of a second higher harmonic from a reproduced signal of a second signal recorded on the magnetic recording medium. The calculation module is configured to calculate a non-linear transition shift of the magnetic recording medium by calculating an arcsine function of a value obtained by dividing the component of the second higher harmonic by the component of the first higher harmonic.

### CROSS-REFERENCE TO RELATED APPLICATIONS

This application is based upon and claims the benefit of priority from Japanese Patent Application No. 2010-144002, filed on Jun. 24, 2010, the entire contents of which are incorporated herein by reference.

### FIELD

Embodiments described herein relate generally to a nonlinearity measurement apparatus, a nonlinearity measurement method, and a magnetic recording and reproduction apparatus.

### BACKGROUND

Recently, in accordance with increasing density of a magnetic recording and reproduction apparatus and increasing data transfer speed, it is necessitated to measure a nonlinear transition shift (NLTS) for understanding the NLTS caused in a magnetic head, a recording medium, a recording and reproduction transfer system, and/or the like. The NLTS is data which is necessary for quantitative understanding of degree of influence of data right in front of recording data or data few bits in front of the recording data, on the recording data. Conventionally, there is known a technique for determining the NLTS using arccosine.

However, in the conventional technique, a sign of the NLTS always comes out to be positive, irrespective of whether a bit interval increases or decreases, because the arccosine is used. Therefore, it is difficult to determine whether the bit interval is increased or decreased.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a functional configuration of a magnetic recording and reproduction apparatus according to an embodiment;

FIG. 2 is an exemplary graph illustrating relationship between V_{ab} and NLTS in the embodiment;

FIG. 3 is an exemplary block diagram of a hardware configuration of the magnetic recording and reproduction apparatus in the embodiment; and

FIG. 4 is a flowchart of NLTS measurement process executed by the magnetic recording and reproduction apparatus in the embodiment.

### DETAILED DESCRIPTION

In general, according to one embodiment, a nonlinearity measurement apparatus comprises: a first measurement module, a second measurement module, and a calculation module. The first measurement module is configured to measure a component of a first higher harmonic from a reproduced signal of a first signal recorded on a magnetic recording medium. The second measurement module is configured to measure a component of a second higher harmonic from a reproduced signal of a second signal recorded on the magnetic recording medium. The calculation module is configured to calculate a nonlinear transition shift of the magnetic recording medium by calculating an arcsine function of a value obtained by dividing the component of the second higher harmonic by the component of the first higher harmonic.

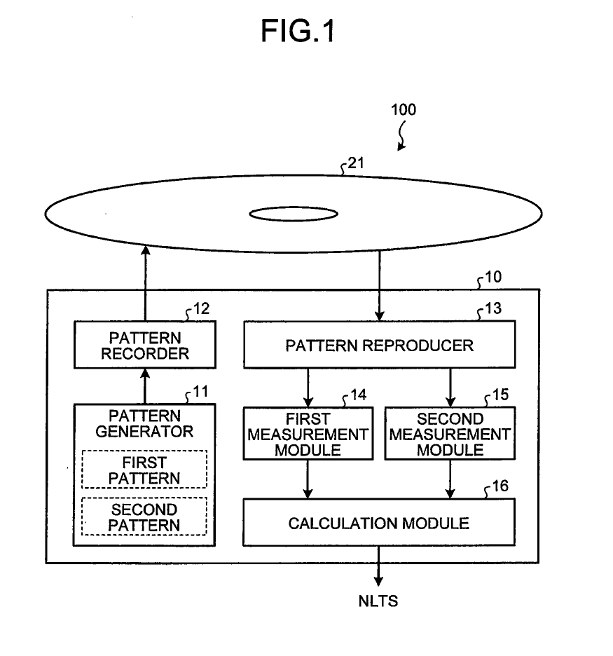

FIG. 1 is a diagram schematically illustrating a functional configuration of a magnetic recording and reproduction apparatus 100 according to an embodiment. The magnetic recording and reproduction apparatus 100 comprises a magnetic disk 21 and a nonlinearity measurement module 10. The nonlinearity measurement module 10 is configured to calculate a nonlinear transition shift (NLTS) of magnetic recording on and magnetic reproduction from the magnetic disk 21.

As illustrated in FIG. 1, the nonlinearity measurement module 10 of the magnetic recording and reproduction apparatus 100 comprises a pattern generator 11, a pattern recording module 12, a pattern reproducer 13, a first measurement module 14, a second measurement module 15, and a calculation module 16.

The pattern generator 11 is configured to generate a first pattern (also referred to as fundamental pattern or fundamental signal) and a second pattern (also referred to as measured pattern or measured signal), and outputs the first and second patterns to the pattern recording module 12. In particular, the pattern generator 11 generates a first pattern configured by a bit sequence of A bits. The pattern generator 11 further generates the second pattern based on following Expression (1). The first pattern comprises at least one location at which magnetization is reversed, and the second pattern comprises six locations at which magnetization are reversed. In Expression (1), A represents a number of bits of the first pattern, which is multiple of 10. Further, B is obtained by dividing A by 5, and T represents a bit period.

$$SECOND PATTERN = ( 1 T , ( B - 1 ) T , ( \frac{A}{2} - B ) T , 1 T , ( B - 1 ) T , ( \frac{A}{2} - B ) T ) \qquad ( 1 )$$

For example, when A is assumed to be 20, i.e., a bit sequence contains 20 bits, the pattern generator 11 generates a bit pattern represented by “11111111110000000000” (10T, 10T) in a non-return-to-zero (NRZ) representation as the first pattern. This first pattern comprises the location at which magnetization is reversed at the 10th bit. The NRZ is a technique for recording data by a pulse waveform with a length of a unit code and a pulse length being equal to each other, in a binary signal pulse sequence.

The pattern generator further generates a bit pattern represented by “10001111110111000000” (1T, 3T, 6T, 1T, 3T, 6T) in the NRZ representation as the second pattern, based on Expression (1). This second pattern comprises the locations at which magnetization is reversed at 0th, 1st, 4th, 10th, 11th, and 14th bits.

In the embodiment described in the following, the NLTS is derived using the aforementioned first pattern of “11111111110000000000” and the aforementioned second pattern of “10001111110111000000.”

The pattern recording module 12 stores the first pattern and the second pattern generated by the pattern generator 11 in the magnetic disk 21. The pattern reproducer 13 is configured to read and reproduce the first pattern and the second pattern recorded in the magnetic disk 21.

The first measurement module 14 is configured to measure an amplitude (referred to as harmonic component) of a predetermined first higher harmonic from a reproduction signal of the first pattern magnetically recorded on the magnetic disk 21. In particular, the first measurement module 14 is configured to analyze the first pattern reproduced by the pattern reproducer 13 by the Fast Fourier Transformation (FFT) to measure the fifth-order harmonic component of the first pattern.

The second measurement module 15 is configured to measure a harmonic component of a predetermined second higher harmonic from each of reproduction signals of various types of measured signals magnetically recorded on the magnetic disk 21. In particular, the second measurement module 15 analyzes the second pattern reproduced by the pattern reproducer 13 by the FFT to measure the fifth-order harmonic component of the second pattern.

The first pattern generated by the pattern generator 11 is recorded on the magnetic disk 21 via the pattern recording module 12. Then, data corresponding to the first pattern recorded in the magnetic disk 21 is input to the first measurement module 14 via the pattern reproducer 13. Similarly, the second pattern generated by the pattern generator 11 is recorded in the magnetic disk 21 via the pattern recording module 12. Then, data corresponding to the second pattern recorded in the magnetic disk 21 is input to the second measurement module 15 via the pattern reproducer 13.

In the following embodiment, the first harmonic component measured by the first measurement module 14 and the second harmonic component measured by the second measurement module 15 are assumed to be the fifth-order harmonic component of the fifth order harmonic (M=5).

The calculation module 16 is configured to calculate the NLTS from the first harmonic component measured by the first measurement module 14 and the second harmonic component corresponding to each of the measured signals measured by the second measurement module 15. In the following, calculation of the NLTS is explained.

A repetition frequency (referred to as fundamental frequency) of 20 bits of the first pattern is represented by following Expression (2).

$${f}_{0} = \frac{1}{20 T} \qquad ( 2 )$$

Thus, the frequency of the fifth-order harmonic of the first pattern is obtained by following Expression (3). Further, by substituting f=5f₀ into the expression ω=2πf, an angle in radian of one bit for the fifth-order harmonic of the first pattern is represented by following expression (4).

$$\begin{matrix}5 {f}_{0} = \frac{1}{4 T} & ( 3 ) \\ ω T = 2 π fT = 2 π5 {f}_{0} T = \frac{π}{2} & ( 4 )\end{matrix}$$

The fifth-order harmonic component Vₐ(5fₒ) is expressed by following Expression (5), where Vₐ is an amplitude of the first pattern and H(f) is an impulse response of the reproduced signal.

$$\begin{matrix}{V}_{a} ( 5 {f}_{0 } ) = H ( f ) \{ exp ( j \frac{π}{2} \cdot 0 ) - exp ( j \frac{π}{2} \cdot 10 ) \} \\ = H ( f ) \cdot 2\end{matrix} \qquad ( 5 )$$

Further, as similar to the first pattern, the fifth-order harmonic component V_{b} (5fₒ₉) is expressed by following Expression (6) from among various NLTS types, where V_{b} represents an amplitude of the second pattern comprising a dibit pattern, and H(f) represents an impulse response of the reproduced signal.

$$\begin{matrix}{V}_{b} ( 5 {f}_{0} ) = H ( f ) \{ exp ( j \frac{π}{2} \cdot - 1 ) - exp ( j \frac{π}{2} \cdot n ) + exp ( j \frac{π}{2} \cdot 3 ) - exp ( j \frac{π}{2} \cdot 9 ) + \\ exp ( j \frac{π}{2} \cdot ( 10 + n ) ) - exp ( j \frac{π}{2} \cdot 13 ) \} \\ = H ( f ) \{ - exp ( j \frac{π}{2} ) - exp ( j \frac{π}{2} \cdot n ) - exp ( j \frac{π}{2} ) - exp ( j \frac{π}{2} ) - \\ exp ( j \frac{π}{2} \cdot n ) - exp ( j \frac{π}{2} ) \} \\ = H ( f ) \cdot - 2 \{ 2 exp ( j \frac{π}{2} ) + exp ( j \frac{π}{2} \cdot n ) \}\end{matrix} \qquad ( 6 )$$

Here, Vₐ(5fₒ) and V_{b}(5fₒ) are measured by the first measurement module 14 and the second measurement module 15 via the FFT. Thus, the values thereof are to be absolute values. From above Expressions (5) and (6), V_{ab} obtained by dividing V_{b}(5fₒ) by Vₐ(5fₒ), or in other words, V_{ab} obtained by normalizing V_{b}(5fₒ) by Vₐ(5fₒ), is represented by following Expression (7).

$$\begin{matrix}{V}_{ab} = \frac{\vert {V}_{b} ( 5 {f}_{0} ) \vert}{\vert {V}_{a} ( 5 {f}_{0 } ) \vert} \\ = \frac{\vert - 2 \{ 2 exp ( j \frac{π}{2} ) + exp ( j \frac{π}{2} \cdot n ) \} \vert}{2} \\ = 2 exp ( j \frac{π}{2} ) + exp ( j \frac{π}{2} \cdot n ) \\ = 2 j + exp ( j \frac{π}{2} \cdot n )\end{matrix} \qquad ( 7 )$$

V_{ab} is represented by following Expression (8) if the second term on the right hand side of Expression (7), namely, “exp (j(π/2)n),” is represented by [Re]+j[Im]. Further, square of an absolute value of V_{ab} is represented by Expression (9). Here, “Re” represents real part of “exp (j(π/2)n),” and “Im” represents imaginary part of “exp (j(π/2)n).”

$$\begin{matrix}{V}_{ab} = 2 j + Re + j Im & ( 8 ) \\ \begin{matrix}{\vert {V}_{ab} \vert}^{2} = {Re}^{2} + {( 2 + Im )}^{2} \\ = {Re}^{2} + 4 + 4 Im + {Im}^{2} \\ = 5 + 4 Im\end{matrix} & ( 9 )\end{matrix}$$

Thus, a phase angle φ is represented by following Expression (10) from Expression (9).

$$φ = arcsin ( \frac{{V}_{ab}^{2} - 5}{4} ) \qquad ( 10 )$$

The phase angle of one bit is π/2 radian. Thus, the NLTS can be represented by following Expression (11) obtained from expression (10), while having 1 bit as a reference.

$$\begin{matrix}NLTS = \frac{φ}{( \frac{π}{2} )} \\ = arcsin ( \frac{{V}_{ab}^{2} - 5}{4} ) \cdot \frac{2}{π}\end{matrix} \qquad ( 11 )$$

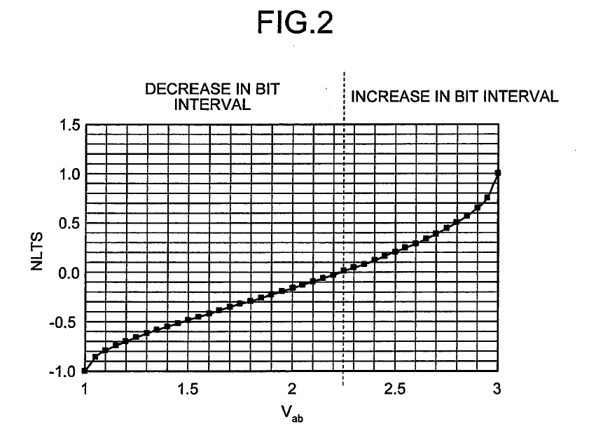

As mentioned above, the calculation module 16 is configured to calculate the NLTS based on the results of the measurement by the first measurement module 14 and the second measurement module 15. Regarding Expression (11), the NLTS is represented by result of calculation using the arcsine function. Thus, the NLTS may have positive or negative sign. Consequently, it becomes possible to easily recognize whether the bit interval is increased or decreased based on the signs of the NLTS. In the following, with reference to FIG. 2, a relationship between the V_{ab} and the NLTS derived by Expression (11) is explained.

FIG. 2 is a diagram illustrating a relationship between V_{ab} and NLTS. In FIG. 2, the latitudinal axis represents V_{ab}, and the longitudinal axis represents NLTS. The value of NLTS of 0 means there exists no NLTS, and this value corresponds to the value of V_{ab} of 2.25.

When the bit interval decreases due to the occurrence of NLTS, V_{ab} decreases from 2.25. On the other hand, when the bit interval increases, V_{ab} increases from 2.25. As described in the above mentioned Expression (11), NLTS is obtained by calculating the arcsine function of the square of V_{ab}. Thus, due to the property of the arcsine function, NLTS obtains the minus sign when the bit interval decreases, and obtains the positive sign when the bit interval increases. Hence, it becomes easy to determine whether the bit interval is increased or decreased based on the change in the signs.

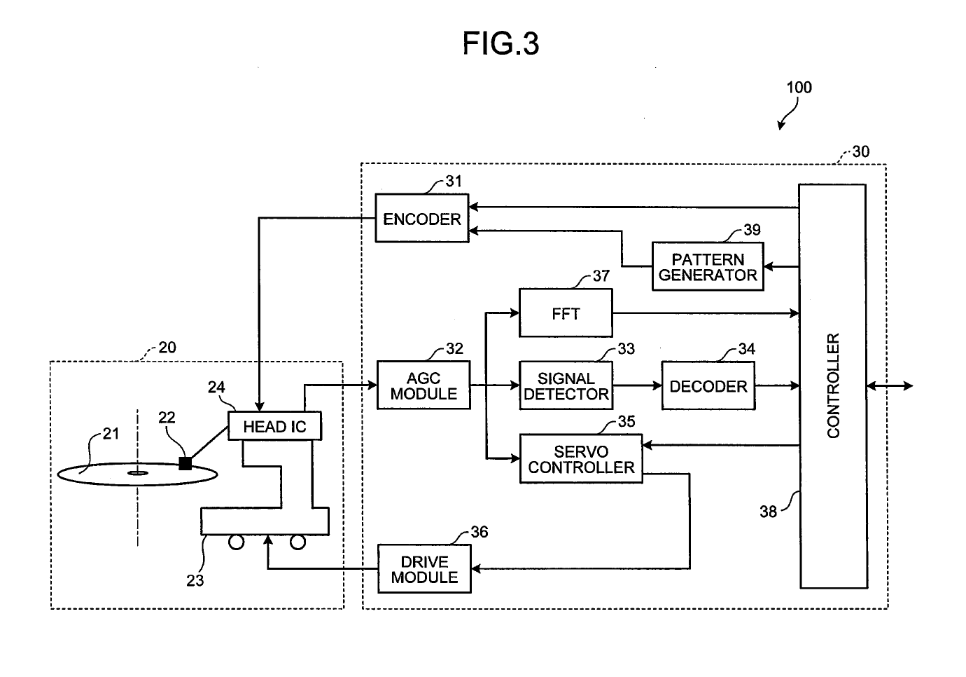

FIG. 3 is a diagram schematically illustrating a hardware configuration of the magnetic recording and reproduction apparatus 100 according to the embodiment. As illustrated in FIG. 3, the magnetic recording and reproduction apparatus 100 comprises a magnetic disk module 20 and a control module 30.

The magnetic disk module 20 comprises the magnetic disk 21, a magnetic head 22, an actuator 23, and a head integrated circuit (IC) 24.

The magnetic disk 21 is configured by a disk shaped medium using a magnetic film with high coercive force. Tracks are formed on the medium. The magnetic disk 21 is rotated by a spindle motor not illustrated, and date recorded on a surface of the magnetic disk 21 is read or data is recoded on the surface by the magnetic head 22.

The magnetic head 22 is configured to read various data recorded on the magnetic disk 21, and write various data on the magnetic disk 21. In particular, the magnetic head 22 is arranged opposite to the magnetic disk 21, and configured to generate magnetic field by recording current supplied thereto. The magnetic head 22 records various data (first pattern or second pattern) on the magnetic disk 21 by magnetizing the magnetic disk 21 in a track traveling direction.

The actuator 23 is configured to move the magnetic head 22 in a radius direction of the magnetic disk 21, and comprises a voice coil motor (VCM) used to position the magnetic head 22 and the like, for example. The actuator is configured to be driven in accordance with drive signals from later-described drive module 36, and moves the magnetic head 22 to a predetermined position.

The head IC 24 is configured to control the reading and writing of data with respect to the magnetic disk 21 by the magnetic head 22. Further, the head IC 24 is configured to amplify the signal read by the magnetic head 22, and supply the signal to an automatic gain control (AGC) module 32 described later.

The control module 30 comprises an encoder 31, the AGC module 32, a signal detector 33, a decoder 34, a servo controller 35, the drive module 36, a Fast Fourier Transform (FFT) 37, a controller 38, and a pattern generator 39. The control module 30 corresponds to the non-linearity measurement module 10 of FIG. 1.

The encoder 31 is configured to convert the recording data provided by the controller 38 and the first and the second pattern generated by the pattern generator 39 to the NRZ data, and output the NRZ data to record the data in the magnetic disk 21.

The AGC module 32 is configured to control amplitude of a signal provided by the head IC 24, and stabilize the amplitude. Further, the AGC module 32 is configured to output the signal provided by the head IC 24 to the signal detector 33, the servo controller 35, and the FFT 37.

The signal detector 33 is configured to detect reproduced data from a signal output from the AGC module 32. The decoder 34 is configured to decode the signal detected by the signal detector 33, and supply the decoded signal to the controller 38.

The servo controller 35 is configured to demodulate a servo signal from the signal supplied by the AGC module 32. Further, the servo controller 35 is configured to generate a drive control signal corresponding to a difference between a current position of the magnetic head 22 and a position to which the data is recorded or from which the data is read, in accordance with the demodulated servo signal and the control signal supplied by the controller 38. Then, the servo controller 35 supplies the generated drive control signal to the drive module 36.

The drive module 36 is configured to generate a drive signal for driving the actuator 23 in accordance with the drive control signal supplied by the servo controller 35. The drive module 36 supplies the generated drive signal to the actuator 23.

The FFT 37 is provided at a downstream side of the AGC module 32. The FFT 37 is configured to detect (measure) the fifth-order harmonic component from the reproduced signal output by the AGC module 32, and output it to the controller 38. That is to say, the FFT 37 functions as the above-described first measurement module 14 and the second measurement module 15.

The controller 38 is configured to control various processes of the magnetic recording and reproduction apparatus 100, and controls switching of the magnetic head 22, positioning of the magnetic head 22 with respect to the magnetic disk 21, reading and writing of data by the magnetic head 22, or the like. The controller 38 is further configured to receive the above-described recording data from outside, and supply the recording data to the encoder 31.

When the NLTS is measured in the magnetic recording and reproduction apparatus 100, the controller 38 receives, for example, an instruction selecting recording data of a bit sequence pattern of the first and the second patterns supplied to the encoder 31, from outside. Then, the controller 38 supplies the instruction to the pattern generator 39. Then, the pattern generator 39 generates the first and the second patterns in accordance with the instruction received from outside.

Further, the controller 38 is configured to obtain the NLTS from Expression (11) based on the fifth-order harmonic component of the first pattern and the fifth-order harmonic component of the second pattern measured by the FFT 37. That is to say, the controller 38 functions as the calculation module 16 calculating the NLTS from the first predetermined higher harmonic component measured by the first measurement module 14 and the second predetermined higher harmonic component measured by the second measurement module 15.

The pattern generator 39 is configured to generate the first and the second patterns based on the control of the controller 38, and supply the generated first and the second patterns to the encoder 31. That is to say, the pattern generator 39 functions as the above-described pattern generator 11.

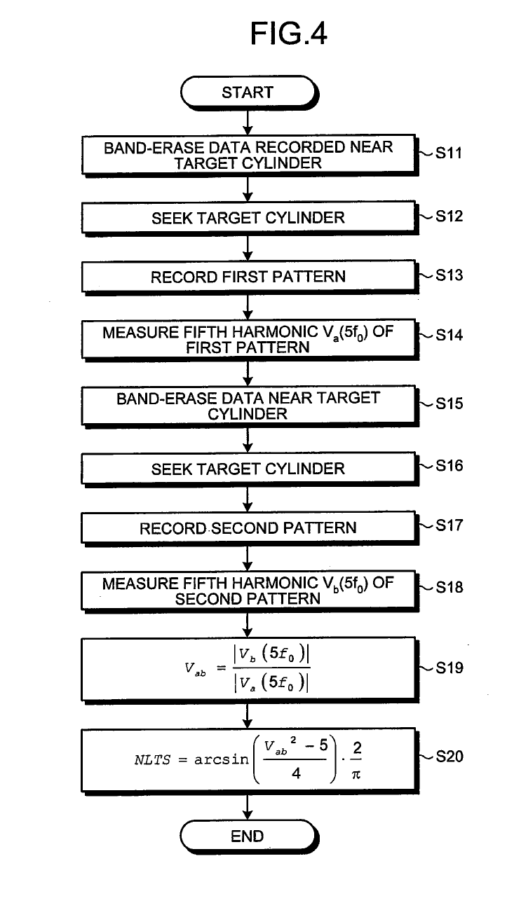

In the following, with reference to FIG. 4, the NLTS measurement process executed by the magnetic recording and reproduction apparatus 100 configured as described above is explained. First, the controller 38 controls the magnetic head 22 to band erase data recorded in a target cylinder and data recorded near the target cylinder (S11).

Next, the controller 38 controls the magnetic head 22 to seek the target cylinder (S12), and controls the magnetic head 22 to record the first pattern generated by the pattern generator 39 in the target cylinder (S13). Then, in accordance with the recording of the first pattern, the controller 38 obtains the fifth-order harmonic component Vₐ(5fₒ) of the first pattern measured by the FFT 37 (S14).

Next, the controller 38 controls the magnetic head 22, and band-erase data recorded in a target cylinder and data recorded near the target cylinder (S15). Then, the controller 38 controls the magnetic head 22 to seek the target cylinder (S16), and controls the magnetic head 22 to records the second pattern generated by the pattern generator 39 in the target cylinder (S17). Then, in accordance with the recording of the second pattern, the controller 38 obtains the fifth-order harmonic component V_{b}(5fₒ) of the second pattern measured by the FFT 37 (S18).

The controller 38 calculates the above-mentioned V_{ab} by dividing the fifth-order harmonic component V_{b}(5fₒ) of the second pattern obtained through S18 by the fifth-order harmonic component Vₐ(5fₒ) of the first pattern obtained through S14 (S19). Next, the controller 38 substitutes V_{ab} calculated via S19 into the above-mentioned Expression (11), and obtains NLTS of the target cylinder. Accordingly, the process ends.

As described above, according to the embodiment, the NLTS can be obtained as a result of calculation of the arcsine function. Hence, the NLTS can be expressed by both positive and negative signs. Therefore, it becomes possible to easily recognize whether the bit interval is decreased or increased based on the signs of the NLTS, thereby convenience for obtaining NLTS can be improved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A nonlinearity measurement apparatus comprising:
a first measurement module configured to measure a component of a first higher harmonic from a reproduced signal of a first signal recorded on a magnetic recording medium;
a second measurement module configured to measure a component of a second higher harmonic from a reproduced signal of a second signal recorded on the magnetic recording medium; and
a calculation module configured to calculate a nonlinear transition shift of the magnetic recording medium by calculating an arcsine function of a value obtained by dividing the component of the second higher harmonic by the component of the first higher harmonic.

2. The nonlinearity measurement apparatus of claim 1, wherein the second signal is configured by a bit sequence represented by Expression (1), where A represents a number of bits of the first signal, B is A/5, and T represents a bit period.
$$( 1 T , ( B - 1 ) T , ( \frac{A}{2} - B ) T , 1 T , ( B - 1 ) T , ( \frac{A}{2} - B ) T ) \qquad ( 1 )$$

3. The nonlinearity measurement apparatus of claim 1, wherein the first signal and the second signal are each configured by a bit sequence of 20 bits.

4. The nonlinearity measurement apparatus of claim 3, wherein
the first signal is configured by a bit sequence “11111111110000000000” represented in the non-return-to-zero code, and
the second signal is configured by a bit sequence “10001111110111000000” represented in the non-return-to-zero code.

5. The nonlinearity measurement apparatus of claim 1, wherein each of the components of the first and the second higher harmonics is a fifth-order harmonic component.

6. The nonlinearity measurement apparatus of claim 1, wherein the calculation module is configured to calculate the non-linear transition shift based on Expression 2, where V_{ab} represents the value obtained by dividing the component of the second higher harmonic by the component of the first higher harmonic.
$$NON \text{-} LINEAR TRANSITION SHIFT = arcsin ( \frac{{V}_{ab}^{2} - 5}{4} ) \cdot \frac{2}{π} \qquad ( 2 )$$

7. The nonlinearity measurement apparatus of claim 1, further comprising:
a generator configured to generate the first signal and the second signal;
a recording module configured to record the first signal and the second signal generated by the generator on the magnetic recording medium; and
a reproducer configured to reproduce the first signal and the second signal recorded on the magnetic recording medium.

8. A nonlinearity measurement method of a magnetic recording and reproduction apparatus comprising a magnetic recording medium, the method comprising:
recording a first signal on a magnetic recording medium;
measuring a component of a first higher harmonic from a reproduced signal of the first signal recorded on the magnetic recording medium;
recording a second signal on the magnetic recording medium;
measuring a component of a second higher harmonic from a reproduced signal of the second signal recorded on the magnetic recording medium; and
calculating a nonlinear transition shift of the magnetic recording medium by calculating an arcsine function of a value obtained by dividing the component of the second higher harmonic by the component of the first higher harmonic.

9. A magnetic recording and reproduction apparatus, comprising:
a magnetic recording medium;
a generator configured to generate a first signal and a second signal;
a recording module configured to record the first signal and the second signal generated by the generator in the magnetic recording medium;
a reproducer configured to reproduce the first signal and the second signal recorded in the magnetic recording medium;
a first measurement module configured to measure a component of a first higher harmonic from the first signal reproduced by the reproducer;
a second measurement module configured to measure a component of a second higher harmonic from the second signal reproduced by the reproducer; and
a calculation module configured to calculate a nonlinear transition shift of the magnetic recording medium by calculating an arcsine function of a value obtained by dividing the component of the second higher harmonic by the component of the first higher harmonic.
